(19) United States
(12) Patent Application Publication
(10) Pub. No.: US 2026/0129668 A1
(43) Pub. Date: May 7, 2026

(54) TRANSMITTING DATA BASED ON PRIORITY INHERITANCE AND LOGICAL CHANNEL PRIORITIZATION

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US)

(21) Appl. No.: 19/377,410

(22) Filed: Nov. 3, 2025

Related U.S. Application Data
(60) Provisional application No. 63/717,212, filed on Nov. 6, 2024.

(51) Int. Cl. H04W 72/563; H04W 72/044; H04W 72/21; H04W 72/543

(52) U.S. Cl. CPC H04W 72/563; H04W 72/044; H04W 72/21; H04W 72/543

(57) ABSTRACT

Various aspects of the present disclosure generally relate to wireless communication. In some aspects, a user equipment (UE) may receive one or more parameters associated with a logical channel prioritization, wherein: a first logical channel (LC) is associated with a first priority and a second LC is associated with a second priority, the second priority is prioritized over the first priority in accordance with the logical channel prioritization, and the second priority of the second LC is assigned to the first LC in accordance with a priority inheritance based on a portion of data associated with the first LC having a delay that satisfies a delay threshold. The UE may transmit the portion of data associated with the first LC and a portion of data associated with the second LC based at least in part on the priority inheritance and the one or more parameters. Numerous other aspects are described.

### CROSS-REFERENCE TO RELATED APPLICATION

This Patent Application claims priority to U.S. Provisional Patent Application No. 63/717,212, filed on November 6, 2024, entitled “TRANSMITTING DATA BASED ON PRIORITY INHERITANCE AND LOGICAL CHANNEL PRIORITIZATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with transmitting data based on priority inheritance and logical channel prioritization.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication at a user equipment (UE) includes one or more memories; and one or more processors, coupled to the one or more memories, configured to cause the UE to: receive one or more parameters associated with a logical channel prioritization (LCP), wherein: a first logical channel (LC) is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and transmit, via an uplink grant, the portion of data associated with the first LC and a portion of data associated with the second LC based at least in part on the priority inheritance and the one or more parameters.

In some implementations, an apparatus for wireless communication at a network node includes one or more memories; and one or more processors, coupled to the one or more memories, configured to cause the network node to: transmit one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and receive, via an uplink grant, the portion of data associated with the first LC and a portion of data associated with the second LC based at least in part on the priority inheritance and the one or more parameters.

In some implementations, a method of wireless communication performed by a UE includes receiving one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and transmitting, via an uplink grant, the portion of data associated with the first LC and a portion of data associated with the second LC based at least in part on the priority inheritance and the one or more parameters.

In some implementations, a method of wireless communication performed by a network node includes transmitting one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and receiving, via an uplink grant, the portion of data associated with the first LC and a portion of data associated with the second LC based at least in part on the priority inheritance and the one or more parameters.

In some implementations, a non-transitory computer-readable medium storing a set of instructions for wireless communication includes one or more instructions that, when executed by one or more processors of a UE, cause the UE to: receive one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and transmit, via an uplink grant, the portion of data associated with the first LC and a portion of data associated with the second LC based at least in part on the priority inheritance and the one or more parameters.

In some implementations, a non-transitory computer-readable medium storing a set of instructions for wireless communication includes one or more instructions that, when executed by one or more processors of a network node, cause the network node to: transmit one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and receive, via an uplink grant, the portion of data associated with the first LC and a portion of data associated with the second LC based at least in part on the priority inheritance and the one or more parameters.

In some implementations, an apparatus for wireless communication includes means for receiving one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and means for transmitting, via an uplink grant, the portion of data associated with the first LC and a portion of data associated with the second LC based at least in part on the priority inheritance and the one or more parameters.

In some implementations, an apparatus for wireless communication includes means for transmitting one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and means for receiving, via an uplink grant, the portion of data associated with the first LC and a portion of data associated with the second LC based at least in part on the priority inheritance and the one or more parameters.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIG. 3 is a diagram illustrating an example associated with transmitting data based on priority inheritance and logical channel prioritization, in accordance with the present disclosure.

FIG. 4 is a flowchart illustrating an example process performed, for example, by a UE, in accordance with the present disclosure.

FIG. 5 is a flowchart illustrating an example process performed, for example, by a network node, in accordance with the present disclosure.

FIGS. 6-7 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a medium access control (MAC) layer, different logical channels (LCs) may have different priorities and associated logical channel prioritization (LCP) configurations from a network node. Configuration parameters associated with the different priorities and/or the associated LCP configurations may be configured based at least in part on a type of traffic mapped to a radio bearer or an LC, and based at least in part on associated quality of service (QoS) requirements. A priority associated with the LC may ensure that traffic during a grant utilization is prioritized. The configuration parameters may be part of a MAC LC configuration during a resource block (RB) reconfiguration procedure. The configuration parameters may be semi-static across reconfigurations. The configuration parameters may not be dynamically updated based at least in part on instantaneous traffic conditions due to ongoing applications at a user equipment (UE). The configuration parameters may not be dynamically updated based at least in part on scheduler grant patterns at the network node due to a loading in a cell.

An LCP procedure may be applied when a new transmission is performed. A radio resource control (RRC) signaling may control a scheduling of uplink data. The RRC signaling may indicate, for each LC per MAC entity, a priority where an increasing priority value indicates a lower priority level, a prioritized bit rate (prioritisedBitRate) which sets a prioritized bit rate (PBR), and a bucket size duration (bucketSizeDuration) which sets a bucket size duration (BSD). The RRC signaling may additionally control the LCP procedure by configuring mapping restrictions for each LC.

Two LCs may be denoted as LCx and LCy, where the LCx may be associated with a low priority and the LCy may be associated with a high priority. When a given LCx (low priority) has outstanding delay sensitive data which is less than a configured delay threshold, that LCx may inherit the high priority associated with LCy during an LCP procedure to prioritize a total traffic. The LCx, which is typically associated with the low priority, may inherit the high priority associated with the LCy based at least in part on a priority inheritance. In this example, when the LCx inherits the high priority, the LCx may have a higher priority than the LCy. Even though an amount of data that has a delay budget (e.g., the outstanding delay sensitive data) is only a portion of the total data associated with the LCx, due to the priority inheritance, all data on the LCx may be able to be transmitted with the high priority. In other words, as long as some data is delay sensitive for the LCx (the amount of data satisfies the configured delay threshold), then remaining non-delay-sensitive data associated with the LCx may also utilize the high priority. The priority inheritance may be favorable for the LCx, but data on the LCy (which is also associated with the high priority) may become delayed. The priority inheritance may result in a priority inversion in a scheduler algorithm, where priorities of the LCx and the LCy may effectively become reversed. When the LCx has periodic data that satisfies the configured delay threshold, all grants from the network node may be consumed by the LCx, which may negatively impact a QoS requirement of the LCy, or which may push traffic associated with the LCy to also satisfy the configured delay threshold. As a result, an overall system performance may be degraded.

Various aspects relate generally to priority inheritance between LCs. Some aspects more specifically relate to transmitting data based on priority inheritance and LCP. In some examples, a UE may receive, from a network node, one or more parameters associated with an LCP. The one or more parameters may include a defined number of bytes, a defined number of milliseconds, a defined number of occasions, and/or a defined number of grant opportunities. In one example, the defined number of bytes may correspond to a threshold value of bytes or a range of bytes. The defined number of milliseconds may correspond to a threshold value of milliseconds or a range of milliseconds. The defined number of occasions may correspond to a threshold value of occasions or a range of occasions. The defined number of grant opportunities may correspond to a threshold value of grant opportunities or a range of grant opportunities. In other words, the one or more parameters may include threshold values or ranges associated with the defined number of bytes, the defined number of milliseconds, the defined number of occasions, and/or the defined number of grant opportunities. For example, the one or more parameters may include a threshold number of bytes, a threshold time period, a threshold number of occasions, and/or a threshold number of grant opportunities. The one or more parameters may include an indicated number of bytes, an indicated time period, an indicated number of occasions, and/or an indicated number of grant opportunities.

In some aspects, the UE may identify a first LC (e.g., LCx) associated with a first priority and a second LC (e.g., LCy) associated with a second priority. The first priority may be a low priority and the second priority may be a high priority. The UE may assign the second priority of the second LC to the first LC in accordance with a priority inheritance (e.g., the first LC may inherit the second priority (high priority) of the second LC). The UE may assign the second priority of the second LC to the first LC based at least in part on a portion of data associated with the first LC having a delay that satisfies a delay threshold. The portion of data may be delay-sensitive data. The UE may transmit, to the network node via an uplink grant, the portion of data associated with the first LC and a portion of data associated with the second LC based at least in part on the priority inheritance and the one or more parameters. In some aspects, the UE may transmit, to the network node, data up to a defined number of bytes in a time period, such as a last defined number of milliseconds, in accordance with the priority inheritance, where the one or more parameters may indicate the defined number of bytes and the time period, such as the last defined number of milliseconds. The last defined number of milliseconds may refer to a latest defined number of milliseconds or a most recent defined number of milliseconds. In some aspects, the UE may transmit, to the network node, data up to a defined number of occasions in a last defined number of grant opportunities in accordance with the priority inheritance, where the one or more parameters may indicate the defined number of occasions and the last defined number of grant opportunities. The last defined number of grant opportunities may refer to a latest defined number of grant opportunities or a most recent defined number of grant opportunities. In some aspects, the UE may transmit, to the network node, data up to a defined number of occasions in a last defined number of milliseconds in accordance with the priority inheritance, where the one or more parameters may indicate the defined number of occasions and the last defined number of milliseconds.

Particular aspects of the subject matter described in this disclosure can be implemented to realize one or more of the following potential advantages. In some examples, by configuring the one or more parameters, the described techniques can be used by the UE to transmit the portion of data associated with the first UE and the portion of data associated with the second LC based at least in part on the priority inheritance and the one or more parameters. When the first LC inherits a priority of the second LC, rather than an entire uplink grant being used for the first LC and none of the uplink grant being used for the second LC, the UE may utilize the one or more parameters to transmit the portion of data associated with the first LC and the portion of data associated with the second LC. For example, the portion of data associated with the first LC may be the delay-sensitive data, whereas remaining data associated with the first LC may be non-delay-sensitive data. The UE may only transmit the delay-sensitive data associated with the first LC via the uplink grant, and the UE may utilize remaining space in the uplink grant to transmit the portion of data associated with the second LC. As a result, data from both the first LC and the second LC may be transmitted to the network node in the same uplink grant, thereby improving an overall system performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

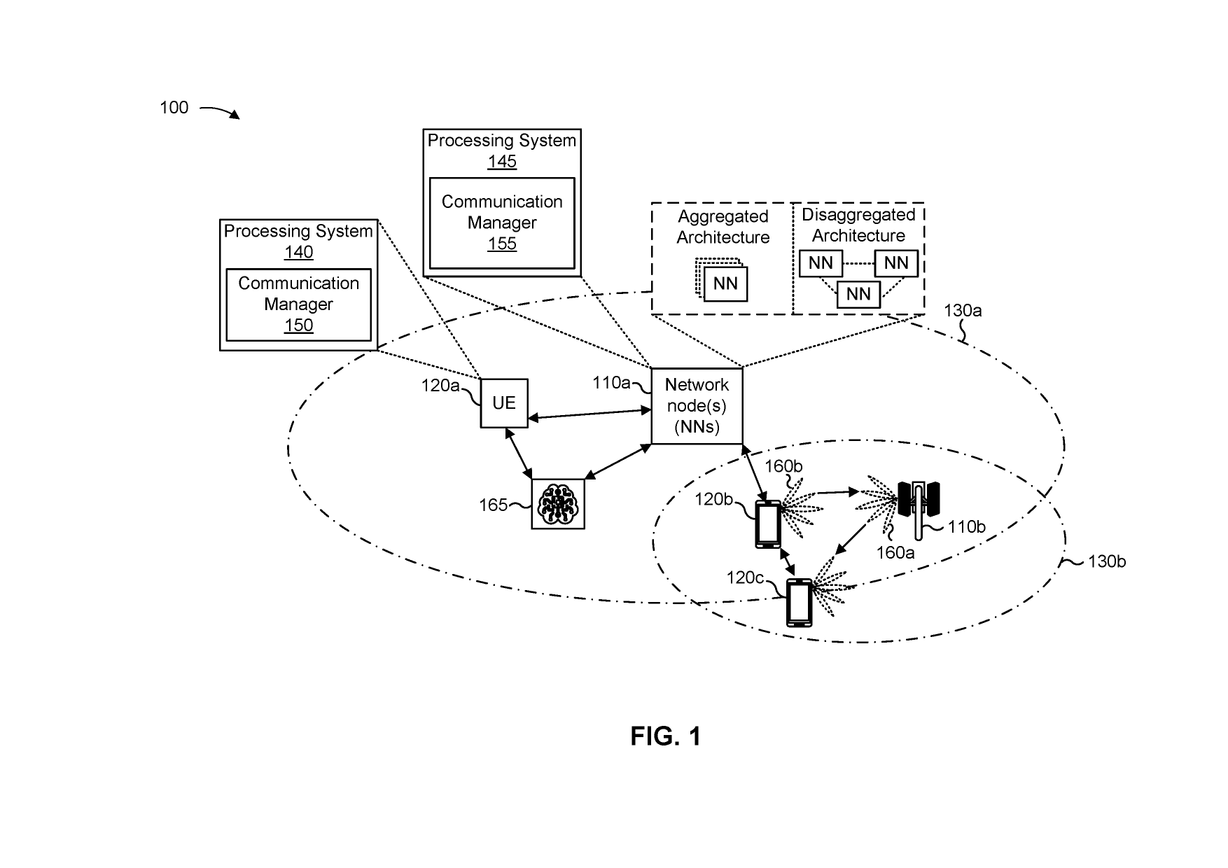

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

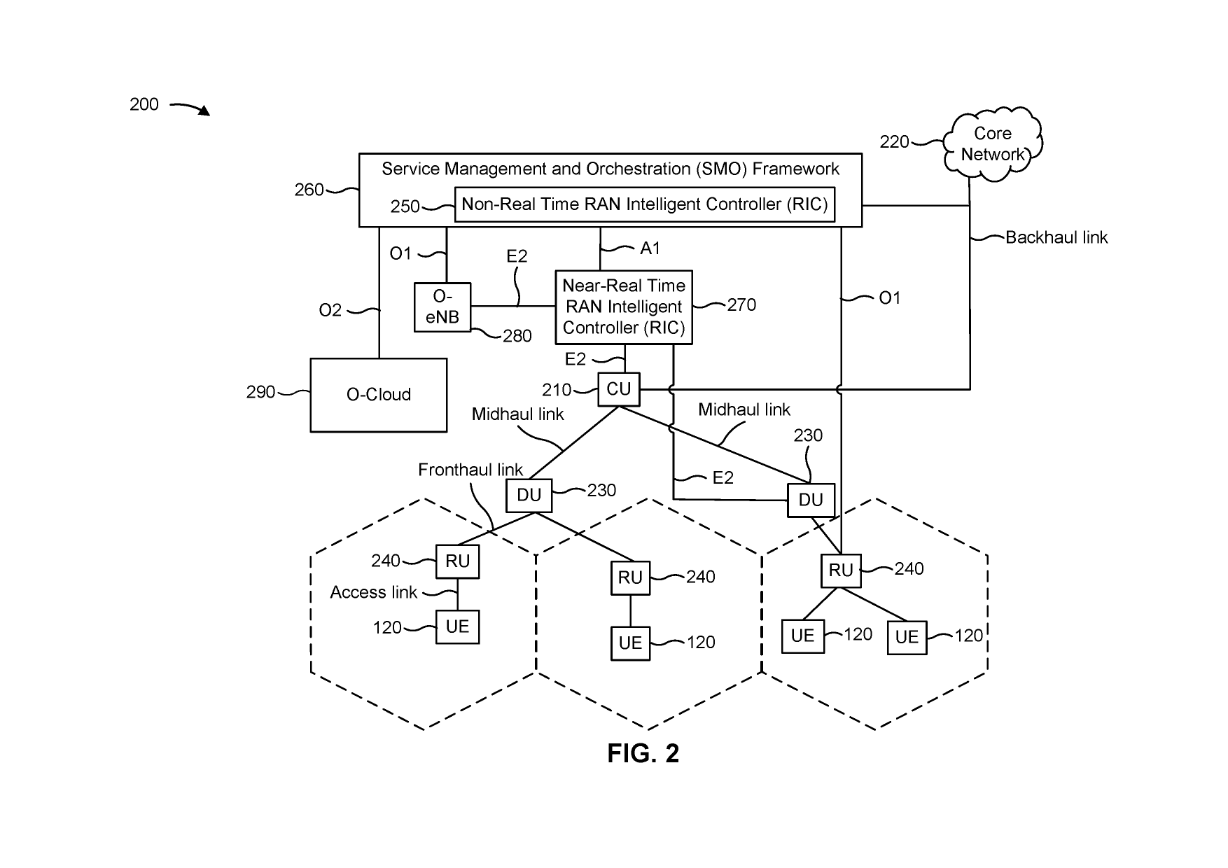

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks (RBs), and resource elements), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, a UE (e.g., the UE 120) may include a communication manager 150. As described in more detail elsewhere herein, the communication manager 150 may receive one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and transmit, via an uplink grant, the portion of data associated with the first LC and a portion of data associated with the second LC based at least in part on the priority inheritance and the one or more parameters. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and receive, via an uplink grant, the portion of data associated with the first LC and a portion of data associated with the second LC based at least in part on the priority inheritance and the one or more parameters. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

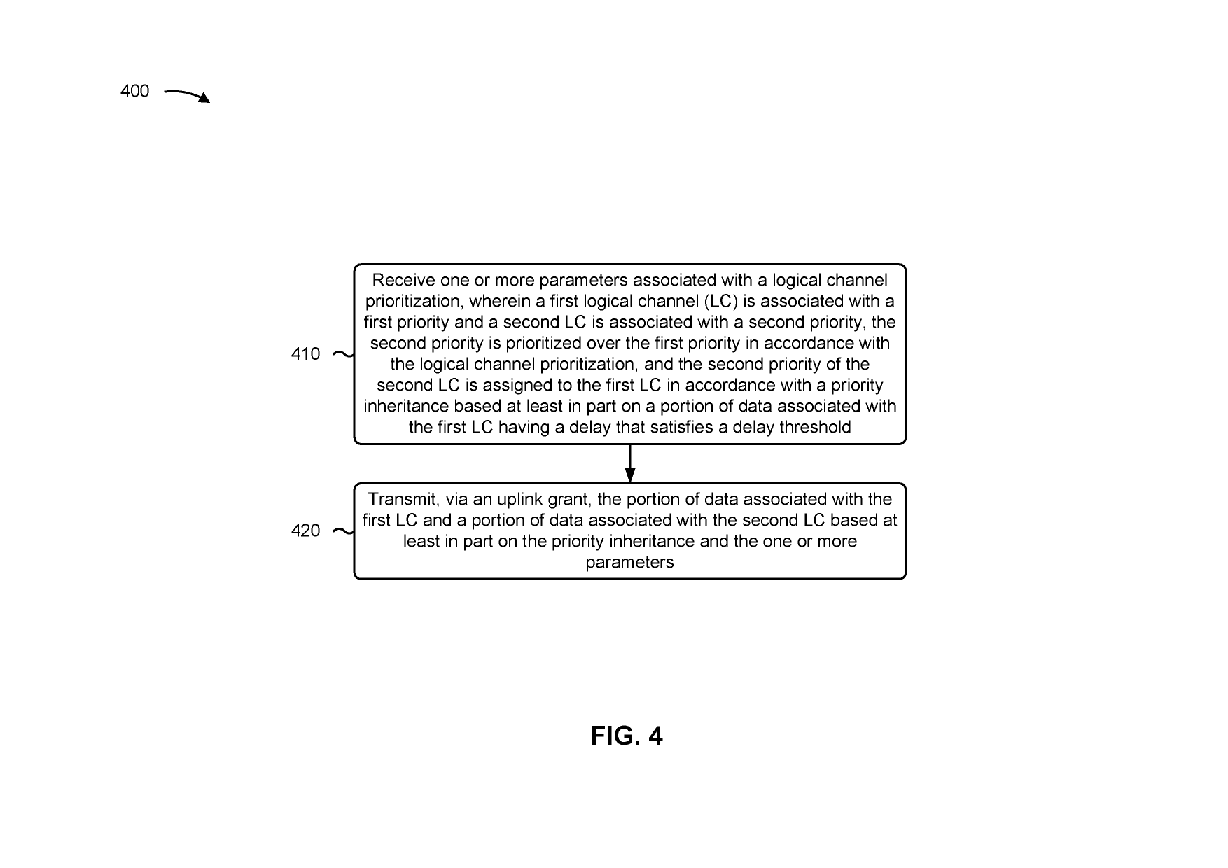

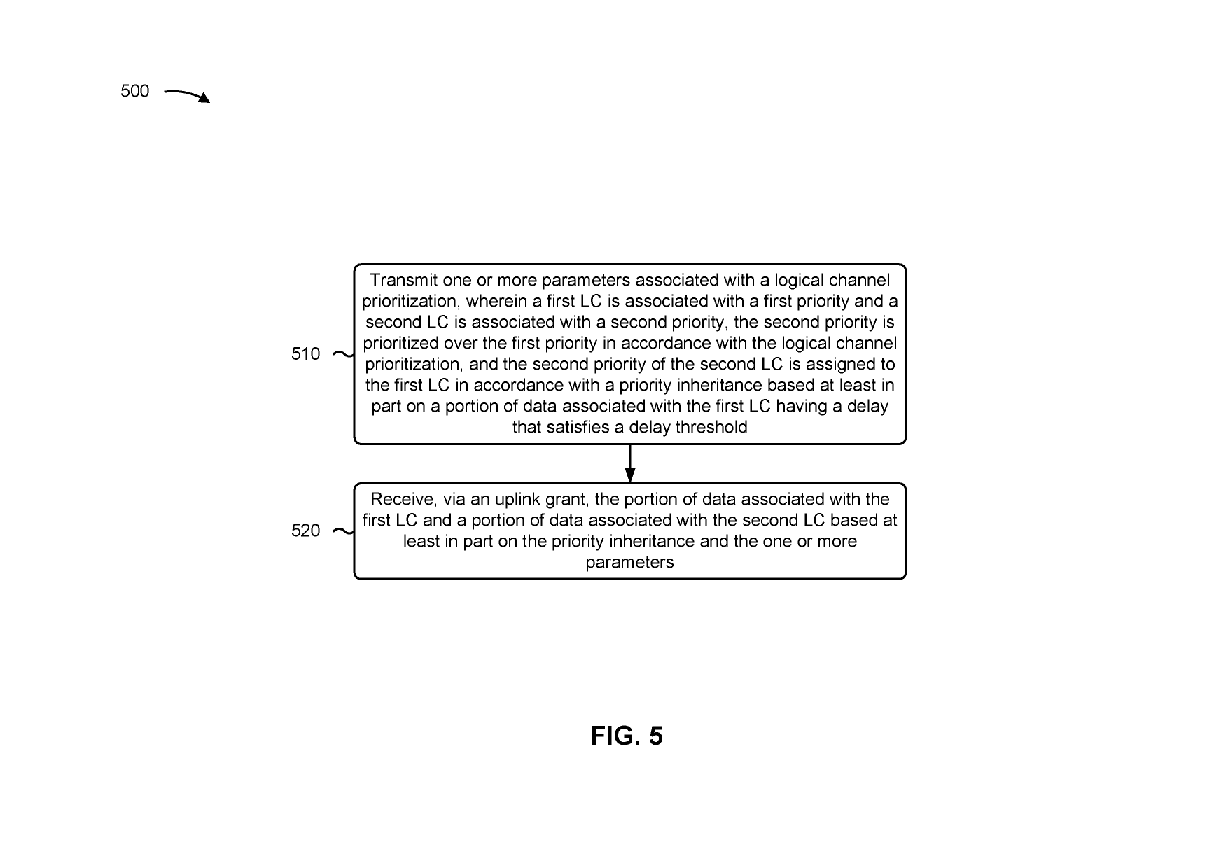

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with transmitting data based on priority inheritance and LCP, as described in more detail elsewhere herein. For example, the processing system 145 of the network node 110, the processing system 140 of the UE 120, the CU 210, the DU 230, or the RU 240 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 400 of FIG. 4, process 500 of FIG. 5, or other processes as described herein. In some examples, executing instructions may include running the instructions, converting the instructions, compiling the instructions, and/or interpreting the instructions, among other examples.

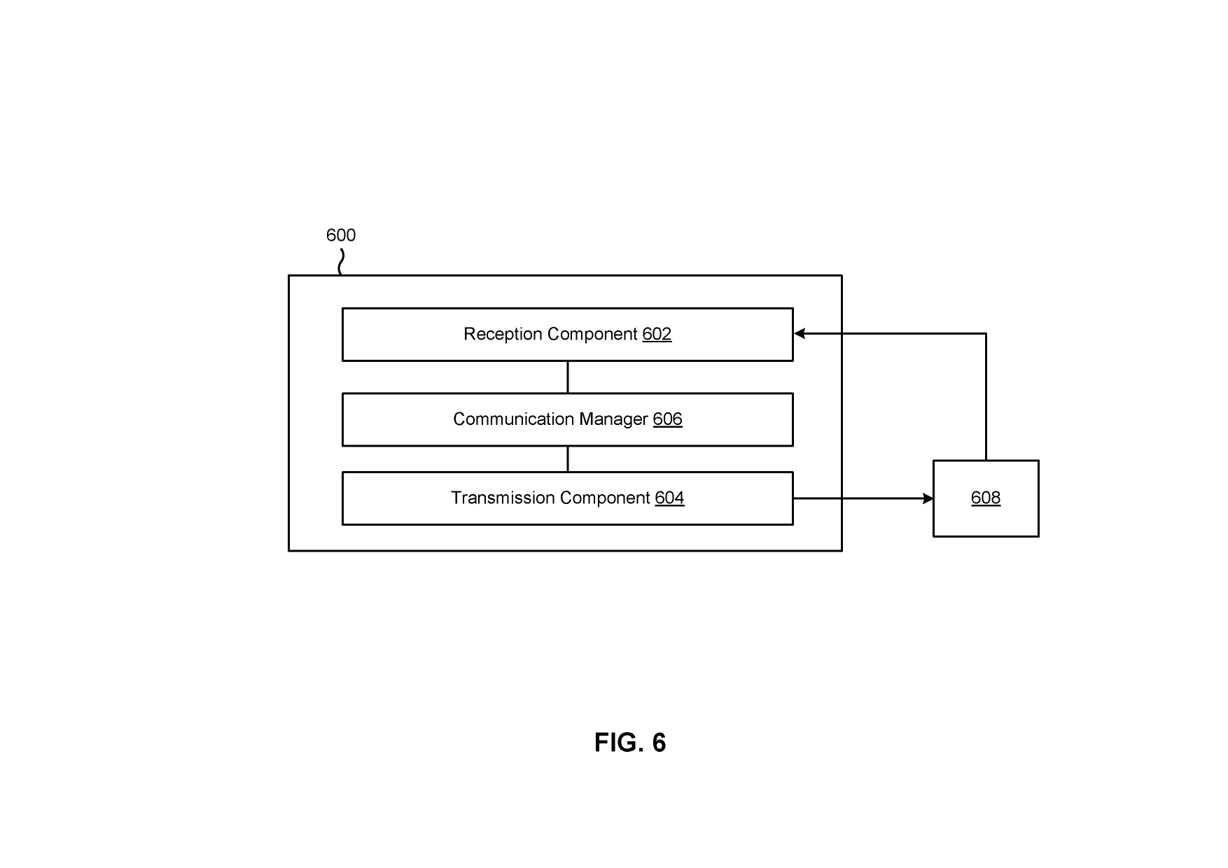

In some aspects, a UE (e.g., the UE 120) includes means for receiving one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and/or means for transmitting, via an uplink grant, the portion of data associated with the first LC and a portion of data associated with the second LC based at least in part on the priority inheritance and the one or more parameters. The means for the UE to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), and/or a transmission component (for example, transmission component 604 depicted and described in connection with FIG. 6), among other examples.

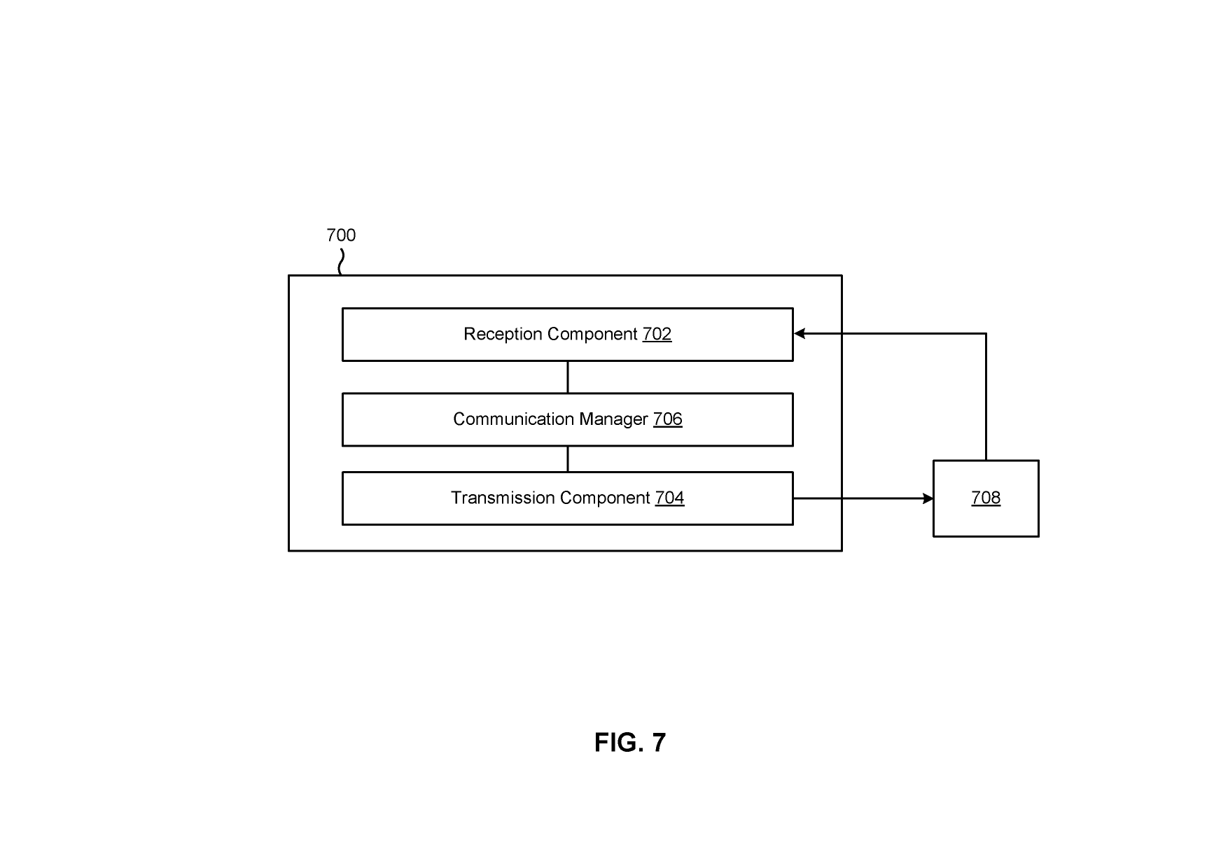

In some aspects, a network node (e.g., the network node 110) includes means for transmitting one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold; and/or means for receiving, via an uplink grant, the portion of data associated with the first LC and a portion of data associated with the second LC based at least in part on the priority inheritance and the one or more parameters. The means for the network node to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

As indicated above, FIG. 2 is provided as an example. Other examples may differ from what is described with regard to FIG. 2.

In a MAC layer, different LCs may have different priorities and associated LCP configurations from a network node. Configuration parameters associated with the different priorities and/or the associated LCP configurations may be configured based at least in part on a type of traffic mapped to a radio bearer or an LC, and based at least in part on associated QoS requirements. A priority associated with the LC may ensure that traffic during a grant utilization is prioritized. The configuration parameters may be part of a MAC LC configuration during an RB reconfiguration procedure. The configuration parameters may be semi-static across reconfigurations. The configuration parameters may not be dynamically updated based at least in part on instantaneous traffic conditions due to ongoing applications at a UE. The configuration parameters may not be dynamically updated based at least in part on scheduler grant patterns at the network node due to a loading in a cell.

An LCP procedure may be applied when a new transmission is performed. An RRC signaling may control a scheduling of uplink data. The RRC signaling may indicate, for each LC per MAC entity, a priority where an increasing priority value indicates a lower priority level, a prioritized bit rate (prioritisedBitRate) which sets a PBR, and a bucket size duration (bucketSizeDuration) which sets a BSD. The RRC signaling may additionally control the LCP procedure by configuring mapping restrictions for each LC. The RRC signaling may indicate an allowed SCS list (allowedSCS-List) which sets an allowed SCS for transmission. The RRC signaling may indicate a maximum PUSCH duration (maxPUSCH-Duration) which sets a maximum PUSCH duration allowed for transmission. The RRC signaling may indicate a configured grant type allowed (configuredGrantType1Allowed) which sets whether a configured grant Type 1 is able to be used for transmission. The RRC signaling may indicate allowed serving cells (allowedServingCells) which sets one or more allowed cells for transmission. The RRC signaling may indicate an allowed configured grant (CG) list (allowedCG-List) which sets one or more allowed configured grants for transmission. The RRC signaling may indicate an allowed physical (PHY) priority index (allowedPHY-PriorityIndex) which sets one or more allowed PHY priority indexes of a dynamic grant for transmission. The RRC signaling may indicate an allowed hybrid automatic repeat request (HARQ) mode (allowedHARQ-mode) which sets an allowed uplink HARQ mode for transmission.

A UE variable may be used for the LCP procedure, where the UE variable may be denoted as Bj, which may be maintained for each LC j. A MAC entity may initialize Bj of an LC to zero when the LC is established. For each LC j, the MAC entity may increment Bj by a product of PBR × T before every instance of the LCP procedure, where T is a time elapsed since Bj was last incremented. When a value of Bj is greater than a bucket size (e.g., PBR × BSD), the MAC entity may set Bj to the bucket size. An exact moment at which the UE updates Bj between LCP procedures may depend on a UE implementation, as long as Bj is up to date at a time when a grant is processed using LCP.

A UE (e.g., UE 120) may support one or more XR functionalities. For example, the UE may be an XR device or may be associated with an XR device (for example, the UE may be connected to the XR device, such as via a wired (for example, universal serial bus (USB), or serial advanced technology attachment (SATA)) connection and/or a wireless (for example, Bluetooth, Wi-Fi, 5G) connection). XR functionalities may include augmented reality (AR), virtual reality (VR), or mixed reality (MR), among other examples. For example, when providing an XR service, the UE may provide rendered data via a display (such as a screen), a set of VR goggles, a heads-up display, or another type of display. The XR device may be an AR glasses device, a VR glass device, or other gaming device.

The XR functionalities may be supported by an application server. The application server may host an application, such as a gaming application, a video streaming application, an XR, VR, or AR application, and/or another type of application for which communication flows of streaming data are provided between a UE and the application server, between an XR device and the application server, and/or between the application server and another device in a wireless communication network. The application server may be included in an edge server, a cloud environment, and/or another type of server environment. The UE and/or an XR device may execute an application client associated with the application hosted by the application server, such as a gaming application client, a video streaming application client, an XR application client, a VR application client, an AR application client, and/or another type of application client.

For XR, various mechanisms and/or procedures may be added to radio protocol layers to provide an immersive user experience. The immersive user experience may be achieved by enhanced latency and throughput requirements, which may be based at least in part on the various mechanisms and/or procedures added to the radio protocol layers. The various mechanisms and/or procedures may be added to a PDCP layer. For example, protocol data unit (PDU) set level requirements may be added. A PDU set may be a group of PDUs, which may represent one application data unit. One or more PDU set characteristics may be used to guide a PDCP level PDU encoding. The one or more PDU set characteristics may include a PDU set delay budget (PSDB), a PDU set error rate (PSER), a PDU set importance (PSI), and/or a PDU set integrated handling information (PSIHI). The various mechanisms and/or procedures may be added to an RLC layer. For example, new triggers for RLC level retransmissions, such as autonomous RLC retransmissions, may be employed. The various mechanisms and/or procedures may be added to a MAC layer. For example, such mechanisms and/or procedures may include an enhancement to a buffer status report (BSR) reporting mechanism, a new BSR table, a delay budget report, a non-integer discontinuous reception (DRX) configuration to align to an XR traffic pattern, and/or an LCP enhancement. The mechanisms and/or procedures may help to improve latency aspects of application traffic, as well as help the network node to provide better grant scheduling based at least in part on remaining data and an associated latency (delay budget) within a flow and across flows. Multiple flows may be associated with a multi-modality.

Some flows may have a dependency across packets from a latency perspective. For example, a video frame may not be complete unless all associated packets in the video frame are transmitted within a delay budget. Some flows may have a cross correlation, such as video frames and audio frames. For example, video frames being delivered without audio frames, or audio frames being delivered without video frames, may result in a poor user experience.

The radio protocol layers may not identify a latency aspect of individual QoS flows. Rather, a BSR and the LCP may be defined at a radio bearer level, which may occasionally result in some packets nearing their delay budget and needing enhanced mechanisms for transmission. Such enhanced mechanisms to transmit the packets nearing their delay budgets may involve a delay status report (DSR), an enhanced BSR trigger/table, and/or an enhanced LCP procedure. The LCP may operate based at least in part on a priority, the PBR, and/or the BSD, which may serve as inputs when calculating an amount of data selected from each LC to utilize a MAC TB from the network node.

Two LCs may be denoted as LCx and LCy, where the LCx may be associated with a low priority and the LCy may be associated with a high priority. When a given LCx (low priority) has outstanding delay sensitive data which is less than a configured delay threshold, that LCx may inherit the high priority associated with LCy during an LCP procedure to prioritize a total traffic. The LCx, which is typically associated with the low priority, may inherit the high priority associated with the LCy based at least in part on a priority inheritance. In this example, when the LCx inherits the high priority, the LCx may have a higher priority than the LCy. Even though an amount of data that has a delay budget (e.g., the outstanding delay sensitive data) is only a portion of a total data associated with the LCx, due to the priority inheritance, all data on the LCx may be able to be transmitted with the high priority. In other words, as long as some data is delay sensitive for the LCx (the amount of data satisfies the configured delay threshold), then remaining non-delay-sensitive data associated with the LCx may also utilize the high priority. The priority inheritance may be favorable for the LCx, but data on the LCy (which is also associated with the high priority) may become delayed. The priority inheritance may result in a priority inversion in a scheduler algorithm, where priorities of the LCx and the LCy may effectively become reversed. When the LCx has periodic data that satisfies the configured delay threshold, all grants from the network node may be consumed by the LCx, which may negatively impact a QoS requirement of the LCy, or which may push traffic associated with the LCy to also satisfy the configured delay threshold. As a result, an overall system performance may be degraded.

As an example, the LCx may have 5000 bytes of total data pending, where 400 bytes of the 5000 bytes may be below a specific delay threshold configured by the network node. In other words, the 400 bytes may be associated with delay sensitive traffic (urgent data), and the remaining 4600 bytes may be associated with non-delay-sensitive data (non-urgent data). The LCy may have 4000 bytes of total data pending. The LCx may be associated with the low priority and the LCy may be associated with the high priority. When a grant is 3000 bytes from the network node, without any priority inheritance, 3000 bytes from the LCy may be transmitted using the grant, which may be based at least in part on the high priority associated with the LCy and the low priority associated with the LCx. When the LCx inherits the priority of the LCy, 3000 bytes from the LCx may be transmitted using the grant and 0 bytes from the LCy may be transmitted using the grant. As a result, the LCy, which may be associated with the high priority, may be associated with an increased delay, thereby degrading the overall system performance.

In various aspects of techniques and apparatuses described herein, a UE may receive, from a network node, one or more parameters associated with an LCP. The one or more parameters may include a defined number of bytes, a defined number of milliseconds, a defined number of occasions, and/or a defined number of grant opportunities. The UE may identify a first LC (e.g., LCx) associated with a first priority and a second LC (e.g., LCy) associated with a second priority. The first priority may be a low priority and the second priority may be a high priority. The UE may assign the second priority of the second LC to the first LC in accordance with a priority inheritance (e.g., the first LC may inherit the second priority (high priority) of the second LC). The UE may assign the second priority of the second LC to the first LC based at least in part on a portion of data associated with the first LC having a delay that satisfies a delay threshold. The portion of data may be delay-sensitive data. The UE may transmit, to the network node via an uplink grant, the portion of data associated with the first LC and a portion of data associated with the second LC based at least in part on the priority inheritance and the one or more parameters. In some aspects, the UE may transmit, to the network node, data up to a defined number of bytes in a time period, such as a last defined number of milliseconds, in accordance with the priority inheritance, where the one or more parameters may indicate the defined number of bytes and the time period, such as the last defined number of milliseconds. In some aspects, the UE may transmit, to the network node, data up to a defined number of occasions in a last defined number of grant opportunities in accordance with the priority inheritance, where the one or more parameters may indicate the defined number of occasions and the last defined number of grant opportunities. In some aspects, the UE may transmit, to the network node, data up to a defined number of occasions in a last defined number of milliseconds in accordance with the priority inheritance, where the one or more parameters may indicate the defined number of occasions and the last defined number of milliseconds.

In some aspects, by configuring the one or more parameters, the UE may transmit the portion of data associated with the first UE and the portion of data associated with the second LC based at least in part on the priority inheritance and the one or more parameters. When the first LC inherits a priority of the second LC, rather than an entire uplink grant being used for the first LC and none of the uplink grant being used for the second LC, the UE may utilize the one or more parameters to transmit the portion of data associated with the first LC and the portion of data associated with the second LC. For example, the portion of data associated with the first LC may be the delay-sensitive data, whereas remaining data associated with the first LC may be non-delay-sensitive data. The UE may only transmit the delay-sensitive data associated with the first LC via the uplink grant, and the UE may utilize remaining space in the uplink grant to transmit the portion of data associated with the second LC. As a result, data from both the first LC and the second LC may be transmitted to the network node in the same uplink grant, thereby improving an overall system performance.

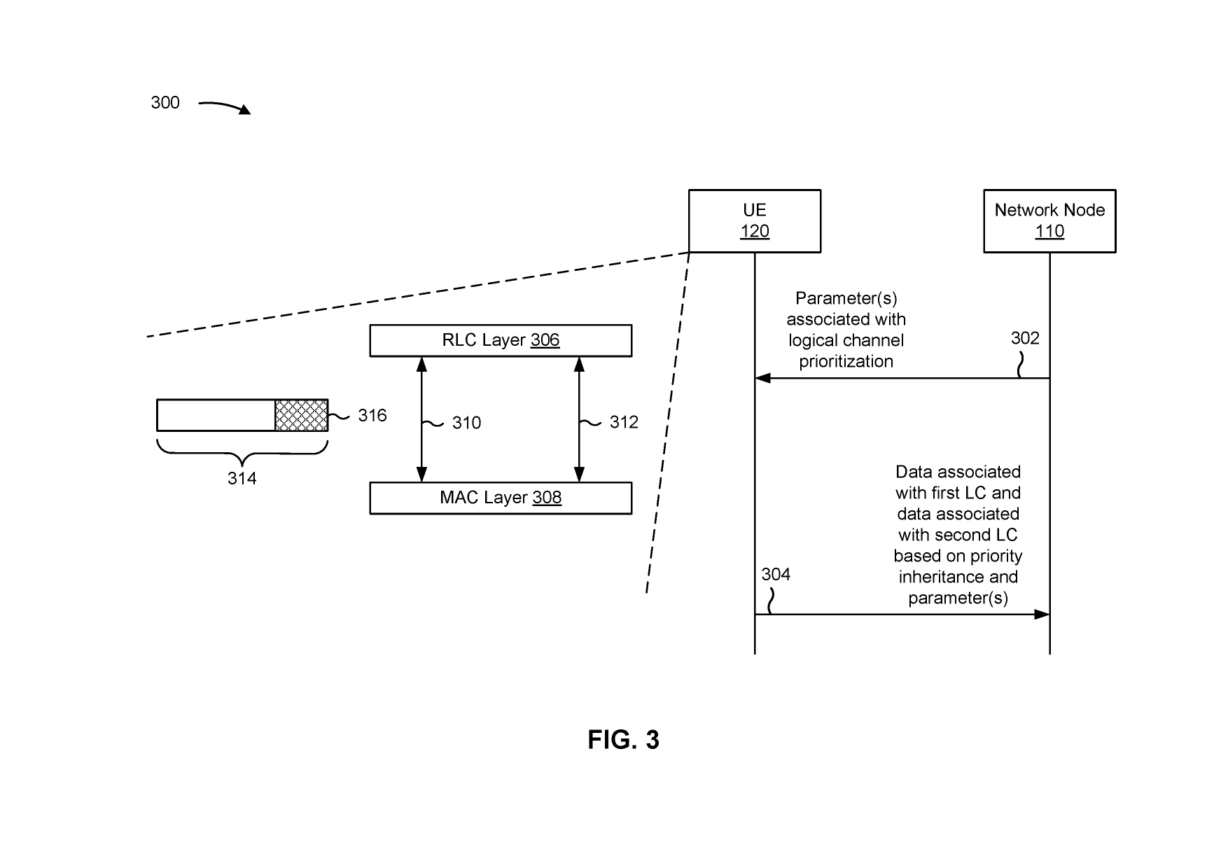

FIG. 3 is a diagram illustrating an example 300 associated with transmitting data based on priority inheritance and LCP, in accordance with the present disclosure. As shown in FIG. 3, example 300 includes communication between a UE 120 and a network node 110. In some aspects, the UE 120 and the network node 110 may be included in a wireless network, such as wireless network 100.

As shown by reference number 302, the UE 120 may receive, from the network node 110, one or more parameters associated with an LCP. The one or more parameters may include a defined number of bytes (X), a defined number of milliseconds (T), a defined number of occasions (N), and/or a defined number of grant opportunities (M). In some aspects, the UE 120 may receive the one or more parameters via an RB configuration or via a MAC-CE. The one or more parameters may be per LC, or the one or more parameters may be across LCs. In other words, the one or more parameters may be for a specific LC, or the one or more parameters may be applicable to multiple LCs. The one or more parameters may be semi-static parameters, or the one or more parameters may be dynamic parameters. The one or more parameters may be based at least in part on a QoS or a radio condition. The one or more parameters may be based at least in part on a QoS requirement, a jitter requirement, and/or a service specific requirement. The one or more parameters may be per PDU session or per network slice.

In some aspects, the UE 120 may identify a first LC (e.g., LCx) 310 associated with a first priority and a second LC (e.g., LCy) associated with a second priority 312, which may be based at least in part on the LCP. The first LC 310 may be a link between an RLC layer 306 of the UE 120 and a MAC layer 308 of the UE 120, and the second LC 312 may be a link between the RLC layer 306 of the UE 120 and the MCA layer 308 of the UE 120. The first LC 310 may be associated with data 314. The first priority may be a low priority and the second priority may be a high priority. In other words, the first LC 310 may be associated with the low priority and the second LC 312 may be associated with the high priority. The second priority may be prioritized over the first priority in accordance with the LCP. In other words, the second LC 312 may be prioritized over the first LC 310 in accordance with the LCP. In some aspects, the UE 120 may assign the second priority of the second LC 312 to the first LC 310 in accordance with a priority inheritance (e.g., the first LC 310 may inherit the second priority (high priority or elevated priority) of the second LC 312). The UE 120 may assign the second priority of the second LC 312 to the first LC 310 based at least in part on a portion of data 316 associated with the first LC 310, of the data 314, having a delay that satisfies a delay threshold. The portion of data 316 may be delay-sensitive data. In other words, when the first LC 310 is associated with at least some (but not necessarily all) delay-sensitive data, the first LC 310 may inherit the second priority (high priority) of the second LC 312. As a result, while initially the first LC 310 was associated with the low priority and the second LC 312 was associated with the high priority, after the priority inheritance, the first LC 310 may have a higher priority than the second LC 312. In this example, based at least in part on the priority inheritance, the first LC 310 may have a highest priority between the first LC 310 and the second LC 312.

In some aspects, the first LC 310 may be associated with the first priority and the second priority. For example, each of the first LC 310 and the second LC 312 may be assigned with two priorities, which may include the first priority and the second priority. The first priority may be a default priority that is active for the first LC 310 by default. The second priority may be an elevated priority in relation to the first priority. The first LC 310 may be associated with the second priority instead of the first priority in accordance with the priority inheritance.

As shown by reference number 304, the UE 120 may transmit, to the network node 110 via an uplink grant, the portion of data 316 associated with the first LC 310 and a portion of data 316 associated with the second LC 312 based at least in part on the priority inheritance and the one or more parameters. In some aspects, the UE 120 may transmit, to the network node 110, data up to a defined number of bytes in a time period, such as a last defined number of milliseconds, in accordance with the priority inheritance, where the one or more parameters may indicate the defined number of bytes and the time period, such as the last defined number of milliseconds. In some aspects, the UE 120 may transmit, to the network node 110, data up to a defined number of occasions in a last defined number of grant opportunities in accordance with the priority inheritance, where the one or more parameters may indicate the defined number of occasions and the last defined number of grant opportunities. In some aspects, the UE 120 may transmit, to the network node 110, data up to a defined number of occasions in a last defined number of milliseconds in accordance with the priority inheritance, where the one or more parameters may indicate the defined number of occasions and the last defined number of milliseconds.

In some aspects, a priority of the first LC 310 may not be allowed to be adjusted in accordance with the priority inheritance, prior to a start of the LCP, when the portion of data 316 exceeds the defined number of bytes. The priority of the LP may not be allowed to be adjusted prior to a the start of an LCP procedure. In some aspects, the UE 120 may transmit, to the network node 110, data based at least in part on a prioritized bit rate associated with the first LC 310, a bucket size duration associated with the first LC 310, and a multiplier, where the one or more parameters may indicate the multiplier. In some aspects, the UE 120 may transmit, to the network node 110, data based at least in part on a mapping restriction for the first LC 310. The mapping restriction may define a serving cell that is not included on an allowed serving cell list or a configured grant that is not included on an allowed configured grant list. The one or more parameters may indicate the mapping restriction. In some aspects, the UE 120 may apply the priority inheritance to the portion of data 316 associated with the first LC 310 during a first round of the LCP, and/or a second round of the LCP, where the first round may be associated with a transmission of data for the first LC and the second LC in accordance with configured parameters, and the second round may be associated with a transmission of data for the first LC based at least in part on a priority.

In some aspects, to overcome issues associated with priority inversion, radio protocol layers may be enhanced to provide additional guard rails to a MAC LCP procedure. A MAC LCP enhancement may be applicable for delay sensitive traffic with respect to the priority inversion. The network node 110 may configure the UE 120 with additional input parameters for an LC (e.g., a given LC), and the UE 120 may transmit uplink data in accordance with the additional input parameters for the given LC. The MAC LCP enhancement may define that the priority inheritance allows for a transmission of data up to X bytes in a last T milliseconds, where X and T may be configured as part of the additional input parameters via the RB configuration or via the MAC-CE. The MAC LCP enhancement may define that the priority inheritance allows for a transmission of data up to N occasions in a last M grant opportunities, where N and M may be configured as part of the additional input parameters via the RB configuration or via the MAC-CE. The MAC LCP enhancement may define that the priority inheritance allows for a transmission of data up to N occasions in a last T milliseconds.

As an example, an LCx may have 5000 bytes of total data pending, where 400 bytes of the 5000 bytes may be below a specific delay threshold configured by the network node 110. In other words, the 400 bytes may be associated with delay sensitive traffic (urgent data), and the remaining 4600 bytes may be associated with non-delay-sensitive data (non-urgent data). The LCy may have 4000 bytes of total data pending. The LCx may be associated with the low priority and the LCy may be associated with the high priority. A grant from the network node 110 may be 3000 bytes. Based at least in part on the MAC LCP enhancement, the LCx may inherit the priority of the LCy, but only the 400 bytes from the LCx that satisfy the specific delay threshold may be transmitted using the grant, and a remaining 2600 bytes available in the grant may be used for the LCy. As a result, only the delay sensitive data associated with the LCx may be transmitted using the grant, which may allow a portion of the LCy to be transmitted using the grant.

In some aspects, the MAC LCP enhancement may define that the LC is not allowed to adjust its priority when an amount of eligible data (whose remaining time is below the configured delay threshold) is more than X bytes before a start of the MAC LCP procedure. The MAC LCP enhancement may define that, during delay threshold conditions, a PBR and a BSD for the LC may be multiplied with a configured multiplier to provide an additional headroom for a greater sized data transmission. The MAC LCP enhancement may define that, during the delay threshold conditions, mapping restrictions for the LC may be overwritten to transmit data using different serving cells than those defined in an allowedServingCells parameter or using a different CG list than defined in an allowedCG-List parameter. Such an override of the mapping restrictions may be time bound or delay threshold traffic bound.

In some aspects, the additional input parameters (e.g., X, N, M, T, the configured multiplier, and/or other mapping restriction relaxations) may be semi-static parameters or dynamic parameters configured by the network node 110, where X, N, M, and T are positive integer values. The additional input parameters may be configured by the network node 110 based at least in part on a dynamic QoS and/or radio conditions. The additional input parameters may be across a plurality of LCs. The additional input parameters may be specific to the LC. The additional input parameters may be based at least in part on QoS requirements. The additional input parameters may be based at least in part on service specific requirements active in a PDU session. The additional input parameters may be based at least in part on service level agreement (SLA) requirements of a network slice.

In some aspects, the priority inheritance that allows transmitting the data up to X bytes in the last T milliseconds, the priority inheritance that allows transmitting the data up to N occasions in the last M grant opportunities, the priority inheritance that allows transmitting the data up to N occasions in the last T milliseconds, and/or the LC being not allowed to adjust its priority when the amount of eligible data is more than X bytes before the start of the LCP procedure may be applied to only a first round of the MAC LCP procedure, only a second round of the MAC LCP procedure, or both the first round and the second round of the MAC LCP procedure. In the first round, an amount of data from the LC that is able to be multiplexed into a next available uplink grant may be subject to a leaky-bucket regulator and a fair queueing policy. In the first round, an LCP algorithm may be followed to send data from each LC as per configured parameters, such as PBR and BSD. In the second round, an amount of data from the LC that is able to be multiplexed into the next available uplink grant may follow a strict priority. The second round may occur after completing configured triggers based at least in part on the data 314 and the LCP, where a remaining grant may be used based at least in part on a priority (e.g., the remaining grant may be used based on priority alone). The second round may only consider the priority.

As indicated above, FIG. 3 is provided as an example. Other examples may differ from what is described with regard to FIG. 3.

FIG. 4 is a diagram illustrating an example process 400 performed, for example, at a UE or an apparatus of a UE, in accordance with the present disclosure. Example process 400 is an example where the apparatus or the UE (e.g., UE 120) performs operations associated with transmitting data based on priority inheritance and LCP.

As shown in FIG. 4, in some aspects, process 400 may include receiving one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold (block 410). For example, the UE (e.g., using reception component 602 and/or communication manager 606, depicted in FIG. 6) may receive one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold, as described above.

As further shown in FIG. 4, in some aspects, process 400 may include transmitting, via an uplink grant, the portion of data associated with the first LC and a portion of data associated with the second LC based at least in part on the priority inheritance and the one or more parameters (block 420). For example, the UE (e.g., using transmission component 604 and/or communication manager 606, depicted in FIG. 6) may transmit, via an uplink grant, the portion of data associated with the first LC and a portion of data associated with the second LC based at least in part on the priority inheritance and the one or more parameters, as described above.

Process 400 may include additional aspects, such as any single aspect or any combination of aspects described below and/or in connection with one or more other processes described elsewhere herein.

In a first aspect, process 400 includes transmitting data up to a defined number of bytes in a time period in accordance with the priority inheritance, wherein the one or more parameters indicate the defined number of bytes and the time period.

In a second aspect, alone or in combination with the first aspect, process 400 includes transmitting data up to a defined number of occasions in a last defined number of grant opportunities in accordance with the priority inheritance, wherein the one or more parameters indicate the defined number of occasions and the last defined number of grant opportunities.

In a third aspect, alone or in combination with one or more of the first and second aspects, process 400 includes transmitting data up to a defined number of occasions in a time period in accordance with the priority inheritance, wherein the one or more parameters indicate the defined number of occasions and the time period.

In a fourth aspect, alone or in combination with one or more of the first through third aspects, a priority of the first LC is not allowed to be adjusted in accordance with the priority inheritance, prior to a start of the LCP, when the portion of data exceeds a defined number of bytes.

In a fifth aspect, alone or in combination with one or more of the first through fourth aspects, process 400 includes transmitting data based at least in part on a prioritized bit rate associated with the first LC, a bucket size duration associated with the first LC, and a multiplier, wherein the one or more parameters indicate the multiplier.

In a sixth aspect, alone or in combination with one or more of the first through fifth aspects, process 400 includes transmitting data based at least in part on a mapping restriction for the first LC, wherein the mapping restriction defines a serving cell that is not included on an allowed serving cell list or a configured grant that is not included on an allowed configured grant list, and the one or more parameters indicate the mapping restriction.

In a seventh aspect, alone or in combination with one or more of the first through sixth aspects, process 400 includes receiving the one or more parameters via a resource block configuration or via a MAC-CE.

In an eighth aspect, alone or in combination with one or more of the first through seventh aspects, the one or more parameters are per LC, or the one or more parameters are across multiple LCs.

In a ninth aspect, alone or in combination with one or more of the first through eighth aspects, the one or more parameters are semi-static parameters, or the one or more parameters are dynamic parameters.

In a tenth aspect, alone or in combination with one or more of the first through ninth aspects, the one or more parameters are based at least in part on a quality of service or a radio condition.

In an eleventh aspect, alone or in combination with one or more of the first through tenth aspects, the one or more parameters are based at least in part on one or more of a quality of service requirement, a jitter requirement, or a service specific requirement.

In a twelfth aspect, alone or in combination with one or more of the first through eleventh aspects, the one or more parameters are per protocol data unit session or per network slice.

In a thirteenth aspect, alone or in combination with one or more of the first through twelfth aspects, process 400 includes applying the priority inheritance to the portion of data associated with the first LC during one or more of a first round of the LCP, or a second round of the LCP, wherein the first round is associated with a transmission of data for the first LC and the second LC in accordance with configured parameters, and wherein the second round is associated with a transmission of data for the first LC based at least in part on a priority.

In a fourteenth aspect, alone or in combination with one or more of the first through thirteenth aspects, the portion of data associated with the first LC is delay-sensitive data.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node, in accordance with the present disclosure. Example process 500 is an example where the apparatus or the network node (e.g., network node 110) performs operations associated with transmitting data based on priority inheritance and LCP.

As shown in FIG. 5, in some aspects, process 500 may include transmitting one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold (block 510). For example, the network node (e.g., using transmission component 704 and/or communication manager 706, depicted in FIG. 7) may transmit one or more parameters associated with an LCP, wherein: a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold, as described above.

As further shown in FIG. 5, in some aspects, process 500 may include receiving, via an uplink grant, the portion of data associated with the first LC and a portion of data associated with the second LC based at least in part on the priority inheritance and the one or more parameters (block 520). For example, the network node (e.g., using reception component 702 and/or communication manager 706, depicted in FIG. 7) may receive, via an uplink grant, the portion of data associated with the first LC and a portion of data associated with the second LC based at least in part on the priority inheritance and the one or more parameters, as described above.

Process 500 may include additional aspects, such as any single aspect or any combination of aspects described below and/or in connection with one or more other processes described elsewhere herein.

In a first aspect, process 500 includes receiving data up to a defined number of bytes in a time period in accordance with the priority inheritance, wherein the one or more parameters indicate the defined number of bytes and the time period.

In a second aspect, alone or in combination with the first aspect, process 500 includes receiving data up to a defined number of occasions in a last defined number of grant opportunities in accordance with the priority inheritance, wherein the one or more parameters indicate the defined number of occasions and the last defined number of grant opportunities.

In a third aspect, alone or in combination with one or more of the first and second aspects, process 500 includes receiving data up to a defined number of occasions in a time period in accordance with the priority inheritance, wherein the one or more parameters indicate the defined number of occasions and the time period.

In a fourth aspect, alone or in combination with one or more of the first through third aspects, a priority of the first LC is not allowed to be adjusted in accordance with the priority inheritance, prior to a start of the LCP, when the portion of data exceeds a defined number of bytes.

In a fifth aspect, alone or in combination with one or more of the first through fourth aspects, process 500 includes receiving data based at least in part on a prioritized bit rate associated with the first LC, a bucket size duration associated with the first LC, and a multiplier, wherein the one or more parameters indicate the multiplier.

In a sixth aspect, alone or in combination with one or more of the first through fifth aspects, process 500 includes receiving data based at least in part on a mapping restriction for the first LC, wherein the mapping restriction defines a serving cell that is not included on an allowed serving cell list or a configured grant that is not included on an allowed configured grant list, and the one or more parameters indicate the mapping restriction.

In a seventh aspect, alone or in combination with one or more of the first through sixth aspects, process 500 includes transmitting the one or more parameters via a resource block configuration or via a MAC-CE.

In an eighth aspect, alone or in combination with one or more of the first through seventh aspects, the one or more parameters are per LC, or the one or more parameters are across multiple LCs.

In a ninth aspect, alone or in combination with one or more of the first through eighth aspects, the one or more parameters are semi-static parameters, or the one or more parameters are dynamic parameters.

In a tenth aspect, alone or in combination with one or more of the first through ninth aspects, the one or more parameters are based at least in part on a quality of service or a radio condition.

In an eleventh aspect, alone or in combination with one or more of the first through tenth aspects, the one or more parameters are based at least in part on one or more of a quality of service requirement, a jitter requirement, or a service specific requirement.

In a twelfth aspect, alone or in combination with one or more of the first through eleventh aspects, the one or more parameters are per protocol data unit session or per network slice.

In a thirteenth aspect, alone or in combination with one or more of the first through twelfth aspects, the priority inheritance is applied to the portion of data associated with the first LC during one or more of a first round of the LCP, or a second round of the LCP, wherein the first round is associated with a transmission of data for the first LC and the second LC in accordance with configured parameters, and wherein the second round is associated with a transmission of data for the first LC based at least in part on a priority.

In a fourteenth aspect, alone or in combination with one or more of the first through thirteenth aspects, the portion of data associated with the first LC is delay-sensitive data.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602, a transmission component 604, and/or a communication manager 606, which may be in communication with one another (for example, via one or more buses and/or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4, or a combination thereof. In some aspects, the apparatus 600 and/or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 and/or the transmission component 604. For example, the communication manager 606 may receive information associated with configuring reception of communications by the reception component 602 and/or transmission of communications by the transmission component 604. Additionally, or alternatively, the communication manager 606 may generate and/or provide control information to the reception component 602 and/or the transmission component 604 to control reception and/or transmission of communications.

The reception component 602 may receive one or more parameters associated with an LCP, wherein a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold. The transmission component 604 may transmit, via an uplink grant, the portion of data associated with the first LC and a portion of data associated with the second LC based at least in part on the priority inheritance and the one or more parameters.

The transmission component 604 may transmit data up to a defined number of bytes in a time period in accordance with the priority inheritance, wherein the one or more parameters indicate the defined number of bytes and the time period. The transmission component 604 may transmit data up to a defined number of occasions in a last defined number of grant opportunities in accordance with the priority inheritance, wherein the one or more parameters indicate the defined number of occasions and the last defined number of grant opportunities.

The transmission component 604 may transmit data up to a defined number of occasions in a time period in accordance with the priority inheritance, wherein the one or more parameters indicate the defined number of occasions and the time period. The transmission component 604 may transmit data based at least in part on a prioritized bit rate associated with the first LC, a bucket size duration associated with the first LC, and a multiplier, wherein the one or more parameters indicate the multiplier.

The transmission component 604 may transmit data based at least in part on a mapping restriction for the first LC, wherein the mapping restriction defines a serving cell that is not included on an allowed serving cell list or a configured grant that is not included on an allowed configured grant list, and wherein the one or more parameters indicate the mapping restriction. The reception component 602 may receive the one or more parameters via a resource block configuration or via a MAC-CE. The communication manager 606 may apply the priority inheritance to the portion of data associated with the first LC during one or more of: a first round of the LCP, or a second round of the LCP, wherein the first round is associated with a transmission of data for the first LC and the second LC in accordance with configured parameters, and wherein the second round is associated with a transmission of data for the first LC based at least in part on a priority.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication, in accordance with the present disclosure. The apparatus 700 may be a network node, or a network node may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 and/or the transmission component 704 may include or may be included in a network interface. The network interface may be configured to obtain and/or output signals for the apparatus 700 via one or more communications links, such as a backhaul link, a midhaul link, and/or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The transmission component 704 may transmit one or more parameters associated with an LCP, wherein a first LC is associated with a first priority and a second LC is associated with a second priority, the second priority is prioritized over the first priority in accordance with the LCP, and the second priority of the second LC is assigned to the first LC in accordance with a priority inheritance based at least in part on a portion of data associated with the first LC having a delay that satisfies a delay threshold. The reception component 702 may receive, via an uplink grant, the portion of data associated with the first LC and a portion of data associated with the second LC based at least in part on the priority inheritance and the one or more parameters.

The reception component 702 may receive data up to a defined number of bytes in a time period in accordance with the priority inheritance, wherein the one or more parameters indicate the defined number of bytes and the time period. The reception component 702 may receive data up to a defined number of occasions in a last defined number of grant opportunities in accordance with the priority inheritance, wherein the one or more parameters indicate the defined number of occasions and the last defined number of grant opportunities.

The reception component 702 may receive data up to a defined number of occasions in a time period in accordance with the priority inheritance, wherein the one or more parameters indicate the defined number of occasions and the time period. The reception component 702 may receive data based at least in part on a prioritized bit rate associated with the first LC, a bucket size duration associated with the first LC, and a multiplier, wherein the one or more parameters indicate the multiplier.

The reception component 702 may receive data based at least in part on a mapping restriction for the first LC, wherein the mapping restriction defines a serving cell that is not included on an allowed serving cell list or a configured grant that is not included on an allowed configured grant list, and wherein the one or more parameters indicate the mapping restriction. The transmission component 704 may transmit the one or more parameters via a resource block configuration or via a MAC-CE.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: receiving one or more parameters associated with a logical channel prioritization, wherein: a first logical channel (LC) is associated with a first priority and a second LC is associated with a second priority, the second priority is prioritized over the first priority in accordance with the logical channel prioritization, and the second priority of the second LC is assigned to the first LC in accordance with a priority inheritance based at least in part on a portion of data associated with the first LC having a delay that satisfies a delay threshold; and transmitting, via an uplink grant, the portion of data associated with the first LC and a portion of data associated with the second LC based at least in part on the priority inheritance and the one or more parameters.

Aspect 2: The method of Aspect 1, wherein transmitting the portion of data associated with the first LC comprises: transmitting data up to a defined number of bytes in a last defined number of milliseconds in accordance with the priority inheritance, wherein the one or more parameters indicate the defined number of bytes and the last defined number of milliseconds.

Aspect 3: The method of any of Aspects 1-2, wherein transmitting the portion of data associated with the first LC comprises: transmitting data up to a defined number of occasions in a last defined number of grant opportunities in accordance with the priority inheritance, wherein the one or more parameters indicate the defined number of occasions and the last defined number of grant opportunities.

Aspect 4: The method of any of Aspects 1-3, wherein transmitting the portion of data associated with the first LC comprises: transmitting data up to a defined number of occasions in a time period in accordance with the priority inheritance, wherein the one or more parameters indicate the defined number of occasions and the time period.

Aspect 5: The method of any of Aspects 1-4, wherein a priority of the first LC is not allowed to be adjusted in accordance with the priority inheritance, prior to a start of the logical channel prioritization, when the portion of data exceeds a defined number of bytes.

Aspect 6: The method of any of Aspects 1-5, wherein transmitting the portion of data associated with the first LC comprises: transmitting data based at least in part on a prioritized bit rate associated with the first LC, a bucket size duration associated with the first LC, and a multiplier, wherein the one or more parameters indicate the multiplier.

Aspect 7: The method of any of Aspects 1-6, wherein transmitting the portion of data associated with the first LC comprises: transmitting data based at least in part on a mapping restriction for the first LC, wherein the mapping restriction defines a serving cell that is not included on an allowed serving cell list or a configured grant that is not included on an allowed configured grant list, and wherein the one or more parameters indicate the mapping restriction.

Aspect 8: The method of any of Aspects 1-7, wherein receiving the one or more parameters comprises: receiving the one or more parameters via a resource block configuration or via a medium access control control element (MAC-CE).

Aspect 9: The method of any of Aspects 1-8, wherein the one or more parameters are per LC, or the one or more parameters are across multiple LCs.

Aspect 10: The method of any of Aspects 1-9, wherein the one or more parameters are semi-static parameters, or the one or more parameters are dynamic parameters.

Aspect 11: The method of any of Aspects 1-10, wherein the one or more parameters are based at least in part on a quality of service or a radio condition.

Aspect 12: The method of any of Aspects 1-11, wherein the one or more parameters are based at least in part on one or more of: a quality of service requirement, a jitter requirement, or a service specific requirement.

Aspect 13: The method of any of Aspects 1-12, wherein the one or more parameters are per protocol data unit session or per network slice.

Aspect 14: The method of any of Aspects 1-13, further comprising: applying the priority inheritance to the portion of data associated with the first LC during one or more of: a first round of the logical channel prioritization, or a second round of the logical channel prioritization, wherein the first round is associated with a transmission of data for the first LC and the second LC in accordance with configured parameters, and wherein the second round is associated with a transmission of data for the first LC based at least in part on a priority.

Aspect 15: The method of any of Aspects 1-14, wherein the portion of data associated with the first LC is delay-sensitive data.

Aspect 16: The method of any of Aspects 1-15, wherein the first LC is associated with the first priority and the second priority, wherein the first priority is a default priority that is active for the first LC by default, and wherein the second priority is an elevated priority in relation to the first priority.

Aspect 17: A method of wireless communication performed by a network node, comprising: transmitting one or more parameters associated with a logical channel prioritization, wherein: a first logical channel (LC) is associated with a first priority and a second LC is associated with a second priority, the second priority is prioritized over the first priority in accordance with the logical channel prioritization, and the second priority of the second LC is assigned to the first LC in accordance with a priority inheritance based at least in part on a portion of data associated with the first LC having a delay that satisfies a delay threshold; and receiving, via an uplink grant, the portion of data associated with the first LC and a portion of data associated with the second LC based at least in part on the priority inheritance and the one or more parameters.

Aspect 18: The method of Aspect 17, wherein receiving the portion of data associated with the first LC comprises: receiving data up to a defined number of bytes in a time period in accordance with the priority inheritance, wherein the one or more parameters indicate the defined number of bytes and the time period.

Aspect 19: The method of any of Aspects 17-18, wherein receiving the portion of data associated with the first LC comprises: receiving data up to a defined number of occasions in a last defined number of grant opportunities in accordance with the priority inheritance, wherein the one or more parameters indicate the defined number of occasions and the last defined number of grant opportunities.

Aspect 20: The method of any of Aspects 17-19, wherein receiving the portion of data associated with the first LC comprises: receiving data up to a defined number of occasions in a time period in accordance with the priority inheritance, wherein the one or more parameters indicate the defined number of occasions and the time period.

Aspect 21: The method of any of Aspects 17-20, wherein a priority of the first LC is not allowed to be adjusted in accordance with the priority inheritance, prior to a start of the logical channel prioritization, when the portion of data exceeds a defined number of bytes.

Aspect 22: The method of any of Aspects 17-21, wherein receiving the portion of data associated with the first LC comprises: receiving data based at least in part on a prioritized bit rate associated with the first LC, a bucket size duration associated with the first LC, and a multiplier, wherein the one or more parameters indicate the multiplier.

Aspect 23: The method of any of Aspects 17-22, wherein receiving the portion of data associated with the first LC comprises: receiving data based at least in part on a mapping restriction for the first LC, wherein the mapping restriction defines a serving cell that is not included on an allowed serving cell list or a configured grant that is not included on an allowed configured grant list, and wherein the one or more parameters indicate the mapping restriction.

Aspect 24: The method of any of Aspects 17-23, wherein transmitting the one or more parameters comprises: transmitting the one or more parameters via a resource block configuration or via a medium access control control element (MAC-CE).

Aspect 25: The method of any of Aspects 17-24, wherein the one or more parameters are per LC, or the one or more parameters are across multiple LCs.

Aspect 26: The method of any of Aspects 17-25, wherein the one or more parameters are semi-static parameters, or the one or more parameters are dynamic parameters.

Aspect 27: The method of any of Aspects 17-26, wherein the one or more parameters are based at least in part on a quality of service or a radio condition.

Aspect 28: The method of any of Aspects 17-27, wherein the one or more parameters are based at least in part on one or more of: a quality of service requirement, a jitter requirement, or a service specific requirement.

Aspect 29: The method of any of Aspects 17-28, wherein the one or more parameters are per protocol data unit session or per network slice.

Aspect 30: The method of any of Aspects 17-29, wherein the priority inheritance is applied to the portion of data associated with the first LC during one or more of: a first round of the logical channel prioritization, or a second round of the logical channel prioritization, wherein the first round is associated with a transmission of data for the first LC and the second LC in accordance with configured parameters, and wherein the second round is associated with a transmission of data for the first LC based at least in part on a priority.

Aspect 31: The method of any of Aspects 17-30, wherein the portion of data associated with the first LC is delay-sensitive data.

Aspect 32: The method of any of Aspects 17-31, wherein the first LC is associated with the first priority and the second priority, wherein the first priority is a default priority that is active for the first LC by default, and wherein the second priority is an elevated priority in relation to the first priority.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive one or more parameters associated with a logical channel prioritization, wherein:
a first logical channel (LC) is associated with a first priority and a second LC is associated with a second priority,
the second priority is prioritized over the first priority in accordance with the logical channel prioritization, and
the second priority of the second LC is assigned to the first LC in accordance with a priority inheritance based at least in part on a portion of data associated with the first LC having a delay that satisfies a delay threshold; and
transmit, via an uplink grant, the portion of data associated with the first LC and a portion of data associated with the second LC based at least in part on the priority inheritance and the one or more parameters.

2. The apparatus of claim 1, wherein the first LC is associated with the first priority and the second priority, wherein the first priority is a default priority that is active for the first LC by default, and wherein the second priority is an elevated priority in relation to the first priority.

3. The apparatus of claim 1, wherein the one or more processors, to transmit the portion of data associated with the first LC, are configured to cause the UE to:
transmit data up to a defined number of bytes in a time period in accordance with the priority inheritance, wherein the one or more parameters indicate the defined number of bytes and the time period.

4. The apparatus of claim 1, wherein the one or more processors, to transmit the portion of data associated with the first LC, are configured to cause the UE to:
transmit data up to a defined number of occasions in a last defined number of grant opportunities in accordance with the priority inheritance, wherein the one or more parameters indicate the defined number of occasions and the last defined number of grant opportunities.

5. The apparatus of claim 1, wherein the one or more processors, to transmit the portion of data associated with the first LC, are configured to cause the UE to:
transmit data up to a defined number of occasions in a time period in accordance with the priority inheritance, wherein the one or more parameters indicate the defined number of occasions and the time period.

6. The apparatus of claim 1, wherein a priority of the first LC is not allowed to be adjusted in accordance with the priority inheritance, prior to a start of the logical channel prioritization, when the portion of data exceeds a defined number of bytes.

7. The apparatus of claim 1, wherein the one or more processors, to transmit the portion of data associated with the first LC, are configured to cause the UE to:
transmit data based at least in part on a prioritized bit rate associated with the first LC, a bucket size duration associated with the first LC, and a multiplier, wherein the one or more parameters indicate the multiplier.

8. The apparatus of claim 1, wherein the one or more processors, to transmit the portion of data associated with the first LC, are configured to cause the UE to:
transmit data based at least in part on a mapping restriction for the first LC, wherein the mapping restriction defines a serving cell that is not included on an allowed serving cell list or a configured grant that is not included on an allowed configured grant list, and wherein the one or more parameters indicate the mapping restriction.

9. The apparatus of claim 1, wherein the one or more processors, to receive the one or more parameters, are configured to cause the UE to:
receive the one or more parameters via a resource block configuration or via a medium access control control element (MAC-CE).

10. The apparatus of claim 1, wherein the one or more parameters are per LC, or the one or more parameters are across multiple LCs.

11. The apparatus of claim 1, wherein the one or more parameters are semi-static parameters, or the one or more parameters are dynamic parameters.

12. The apparatus of claim 1, wherein the one or more parameters are based at least in part on a quality of service or a radio condition.

13. The apparatus of claim 1, wherein the one or more parameters are based at least in part on one or more of: a quality of service requirement, a jitter requirement, or a service specific requirement.

14. The apparatus of claim 1, wherein the one or more parameters are per protocol data unit session or per network slice.

15. The apparatus of claim 1, wherein the one or more processors are further configured to cause the UE to:
apply the priority inheritance to the portion of data associated with the first LC during one or more of: a first round of the logical channel prioritization, or a second round of the logical channel prioritization, wherein the first round is associated with a transmission of data for the first LC and the second LC in accordance with configured parameters, and wherein the second round is associated with a transmission of data for the first LC based at least in part on a priority.

16. The apparatus of claim 1, wherein the portion of data associated with the first LC is delay-sensitive data.

17. An apparatus for wireless communication at a network node, comprising:
one or more memories; and
one or more processors, coupled to the one or more memories, configured to cause the network node to:
transmit one or more parameters associated with a logical channel prioritization, wherein:
a first logical channel (LC) is associated with a first priority and a second LC is associated with a second priority,
the second priority is prioritized over the first priority in accordance with the logical channel prioritization, and
the second priority of the second LC is assigned to the first LC in accordance with a priority inheritance based at least in part on a portion of data associated with the first LC having a delay that satisfies a delay threshold; and
receive, via an uplink grant, the portion of data associated with the first LC and a portion of data associated with the second LC based at least in part on the priority inheritance and the one or more parameters.

18. The apparatus of claim 17, wherein the one or more processors, to receive the portion of data associated with the first LC, are configured to cause the network node to:
receive data up to a defined number of bytes in a time period in accordance with the priority inheritance, wherein the one or more parameters indicate the defined number of bytes and the time period; or
receive data up to a defined number of occasions in a last defined number of grant opportunities in accordance with the priority inheritance, wherein the one or more parameters indicate the defined number of occasions and the last defined number of grant opportunities.

19. The apparatus of claim 17, wherein the one or more processors, to receive the portion of data associated with the first LC, are configured to cause the network node to:
receive data up to a defined number of occasions in a time period in accordance with the priority inheritance, wherein the one or more parameters indicate the defined number of occasions and the time period.

20. A method of wireless communication performed by a user equipment (UE), comprising:
receiving one or more parameters associated with a logical channel prioritization, wherein:
a first logical channel (LC) is associated with a first priority and a second LC is associated with a second priority,
the second priority is prioritized over the first priority in accordance with the logical channel prioritization, and
the second priority of the second LC is assigned to the first LC in accordance with a priority inheritance based at least in part on a portion of data associated with the first LC having a delay that satisfies a delay threshold; and
transmitting, via an uplink grant, the portion of data associated with the first LC and a portion of data associated with the second LC based at least in part on the priority inheritance and the one or more parameters.
